(19) United States
(12) Patent Application Publication
(10) Pub. No.: US 2026/0113276 A1
(43) Pub. Date: Apr. 23, 2026

(54) SYSTEM AND METHOD OF IMPROVING NETWORK TRAFFIC FLOW USING A COMMUNICATION ELIGIBILITY INDICATOR

(71) Applicant: Truist Bank, Charlotte, NC (US)

(72) Inventors: Seshadri Chintalapati, Charlotte, NC (US); Josephine Middleton-Saulny, Atlanta, GA (US); Phani Kumar Ankani, Atlanta, GA (US); Joseph Matthew Law, Ankeny, IA (US)

(73) Assignee: Truist Bank, Charlotte, NC (US)

(21) Appl. No.: 19/289,164

(22) Filed: Aug. 4, 2025

Related U.S. Application Data
(60) Provisional application No. 63/708,829, filed on Oct. 18, 2024.

(51) Int. Cl. H04L 47/24; H04L 9/40; H04W 76/10

(52) U.S. Cl. CPC H04L 47/24; H04L 63/04; H04W 76/10

(57) ABSTRACT

A system and method related to data privacy that uses a communication eligibility indicator are disclosed. The system comprises at least one processing device and at least one memory for storing computer-readable instructions. Upon execution of the computer-readable instructions, the computing system is configured to establish a network connection with at least one agent device and one or more databases. Input data associated with a communication request is received from the at least one agent device and reference data from the one or more databases is retrieved. A data comparison of the input data and the reference data is performed using a predefined algorithm. Based on the data comparison, the at least one processing device generates a communication eligibility indicator and transmits it to the at least one agent device.

### CROSS-REFERENCE TO RELATED APPLICATION

This application claims the benefit of U.S. Provisional Patent Application Serial No. 63/708,829, filed October 18, 2024, the entirety of which is herein incorporated by reference.

### FIELD

The invention relates generally to data privacy, and more particularly to a system and a method related to data privacy that improves process consistency and network traffic flow using a communication eligibility indicator.

### BACKGROUND

Data privacy, or information privacy, often refers to a specific kind of privacy linked to personal information that is provided from individuals to private enterprises in a variety of different applications. Currently, protections for personal information are sector-specific, including personal health information, educational information, children’s information, and financial information, and each has different enforcement mechanisms and unique requirements on consent and disclosure. However, data privacy is ever-evolving in how personal information is used and how it is regulated. The future of data privacy will likely require greater protections and more affirmative rights for individuals.

For example, the Telephone Consumer Protection Act (TCPA) is a U.S. law that regulates telemarketing calls, auto-dialed calls, prerecorded voice messages, text messages, and unsolicited faxes. The main objective of the TCPA is to reduce the number of unwanted telemarketing communications to consumers. Key provisions include requiring businesses to obtain consent before transmitting certain types of communication and allowing consumers to opt out of receiving such communications. Violations of the TCPA can lead to significant penalties for the private enterprises initiating such communications.

Accordingly, it would be desirable to develop a system and a method related to data privacy that improves process consistency and network traffic flow using a communication eligibility indicator, while maintaining legal and regulatory compliance.

### BRIEF SUMMARY

In concordance and agreement with the present invention, a system and a method related to data privacy that improves process consistency and network traffic flow using a communication eligibility indicator, while maintaining legal and regulatory compliance, are newly designed.

In one embodiment, a system that improves network traffic flow, comprises: a computing system including at least one processing device and at least one memory for storing computer-readable instructions, wherein, upon execution of the computer-readable instructions, the computing system is configured to: establish a network connection with at least one agent device and one or more databases; receive, from the at least one agent device, input data associated with a communication request; retrieve, via the network connection, reference data from the one or more databases; perform, by the at least one processing device, a data comparison of the input data and the reference data using a predefined algorithm; generate, by the at least one processing device, a communication eligibility indicator based on the data comparison; and transmit, by the at least one processing device, the communication eligibility indicator to the at least one agent device, wherein the communication eligibility indicator reduces network traffic experienced by the computing system.

In another embodiment, a method that improves network traffic flow, comprises: providing a computing system including at least one processing device and at least one memory for storing computer-readable instructions; establishing a network connection with at least one agent device and one or more databases; receiving, from the at least one agent device, input data associated with a communication request; retrieving, via the network connection, reference data from the one or more databases; performing, by the at least one processing device, a data comparison of the input data and the reference data using a predefined algorithm; generating, by the at least one processing device, a communication eligibility indicator based on the data comparison; and transmitting, by the at least one processing device, the communication eligibility indicator to the at least one agent device, wherein the communication eligibility indicator reduces network traffic experienced by the computing system.

As aspects of some embodiments, the input data is a telephone number of a specific user and/or a potential client.

As aspects of some embodiments, the one or more databases includes a reassigned number database.

As aspects of some embodiments, the one or more databases includes a national do-not-call database.

As aspects of some embodiments, the one or more databases includes at least one state do-not-call database.

As aspects of some embodiments, the one or more databases includes a public safety telephone number database.

As aspects of some embodiments, the one or more databases includes a wireless block and VOIP ID database.

As aspects of some embodiments, the one or more databases includes a litigator database.

As aspects of some embodiments, the one or more databases includes an internal do-not-call database.

As aspects of some embodiments, the one or more databases includes a revoked consent database.

As aspects of some embodiments, the data comparison of the input data and the reference data is performed using a batch process.

As aspects of some embodiments, the communication eligibility indicator is representative of “NO” or denied communication from the at least one agent device.

As aspects of some embodiments, the communication eligibility indicator is representative of “YES” or permitted communication from the at least one agent device.

As aspects of some embodiments, the computing system is further configured to transmit a permitted communication from the at least one agent device manually and/or automatically using one or more outbound systems.

As aspects of some embodiments, the computing system is further configured to generate, by the at least one processing device, an electronic communication containing a specific basis for the communication eligibility indicator.

As aspects of some embodiments, the computing system is further configured to transmit, by the at least one processing device, the electronic communication containing the specific basis for the communication eligibility indicator.

As aspects of some embodiments, the specific basis identifies at least one of the one or more databases that contain the reference data matching the input data.

As aspects of some embodiments, the computing system is further configured to filter the input data and/or the associated communication request using user-specific and/or potential client-specific data privacy preferences and/or marketing preferences.

As aspects of some embodiments, the computing system is further configured to determine permissible communication times and/or methods based on the filtered input data and/or the associated communication request.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

The above-mentioned, and other features and objects of the inventions, and the manner of attaining them will become more apparent and the invention itself will be better understood by reference to the following description of embodiments of the invention taken in conjunction with the accompanying drawings, wherein:

FIG. 1 is a schematic diagram illustrating an enterprise system and environment thereof for implementing a data privacy application in accordance with an embodiment of the presently described subject matter;

FIG. 2 is a flow diagram illustrating an architecture incorporating a data privacy application in accordance with an embodiment of the presently described subject matter; and

FIG. 3 is a flow diagram illustrating a method of improving network traffic flow using a data privacy application in accordance with an embodiment of the presently described subject matter.

### DETAILED DESCRIPTION

Embodiments of the present disclosure will now be described more fully hereinafter with reference to the accompanying drawings, in which some, but not all, embodiments are shown. Indeed, the presently disclosed subject matter may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the subject matter and enable one of ordinary skill in the art to make, use, and practice the subject matter.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present disclosure described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the subject matter. Therefore, it is to be understood that, within the scope of the included claims, the presently described subject matter may be practiced other than as specifically described herein.

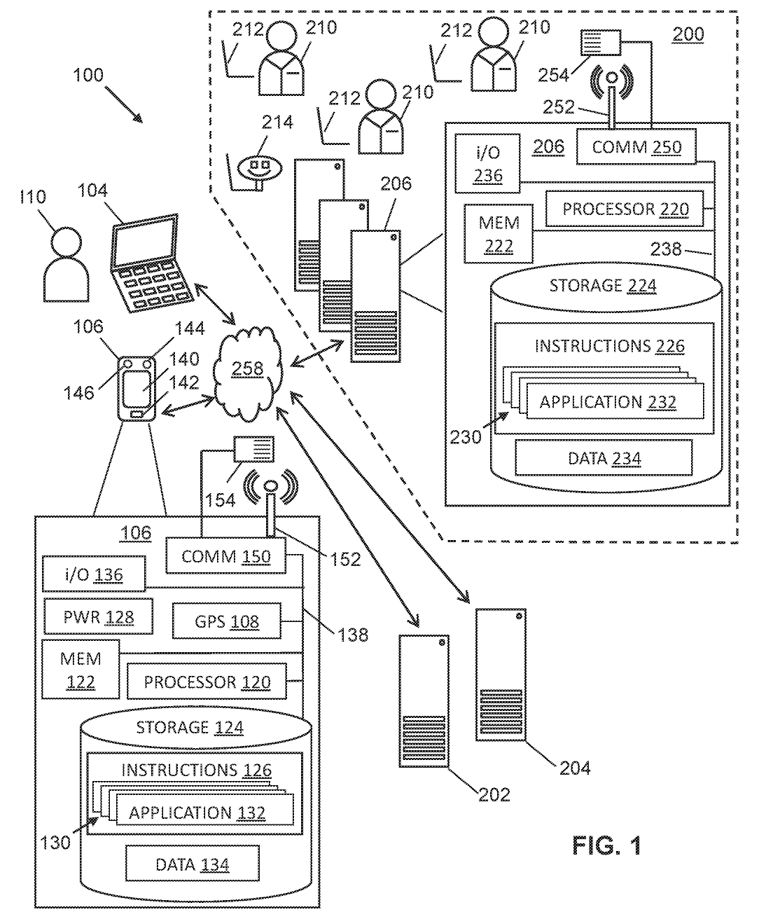

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, users, business entities, government entities, clubs, and groups of any size are all within the scope of these descriptions.

The user device, as illustrated with reference to the mobile device 106, includes components such as, at least one of each of a processor or processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application capable of performing the same or similar tasks to the mobile banking system client application. As used hereinafter, each of the software application associated with the enterprise system 200 and the analogous web browser application capable of performing the same or similar tasks are denoted by reference numeral 132, which may refer to a mobile banking system client application capable of operating on either of the user devices 104, 106.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122. For example, the processing device 120 may be capable of operating a connectivity program, such as the previously described web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like. The application 132 related to the enterprise system 200 may be configured to operate in similar fashion for transmitting such web content.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly – by way of intermediate component(s) - with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can tender any number or type of services and products to one or more users 110. In some examples, an enterprise system 200 tenders products. In some examples, an enterprise system 200 tenders services. Use of “service(s)” or “product(s)” thus relates to either or both in these descriptions. With regard, for example, to online information and interaction services, “service” and “product” are sometimes termed interchangeably. In non-limiting examples, services and products include retail services and products, information services and products, custom services and products, predefined or pre-tendered services and products, consulting services and products, advising services and products, forecasting services and products, internet products and services, social media, and interaction services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of service (POS) representatives, online user service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at user service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications tendering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processor or processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which a data privacy application 232 is represented as a particular example. The storage device 224 can also store at least one database 234 of various other data, which can include, as non-limiting examples, cached data, and files such as those for user accounts, user profiles, account balances, transaction histories, internal enterprise do-not-call data, revoked consent data, files downloaded or received from other devices, and other data items preferred by the user or required or related to any or all of the applications or programs 230. In a non-limiting example, the database 234 may be an internal do-not-call (DNC) database including the internal enterprise do-not-call data. In another non-limiting example, the database 234 may be a revoked consent database including data of those users that have revoked consent for contact by the enterprise system 200.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts or diagrams expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated system 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, users, business entities, banking systems, government entities, clubs, and groups of any size are all within the scope of the descriptions. In at least one example, the external systems 202 and 204 represent a reassigned number database configured to interact with the enterprise system 200 in back-end transactions. In another example, the external systems 202 and 204 represent a national do-not-call (DNC) database configured to interact with the enterprise system 200 in back-end transactions, and in another example, the external systems 202 and 204 represent state do-not-call databases configured to interact with the enterprise system 200 in back-end transactions. In yet another example, the external systems 202 and 204 represent other databases configured to interact with the enterprise system 200 in back-end transactions such as a public safety telephone number database, a wireless block and VOIP ID database, a professional litigator database, and the like.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

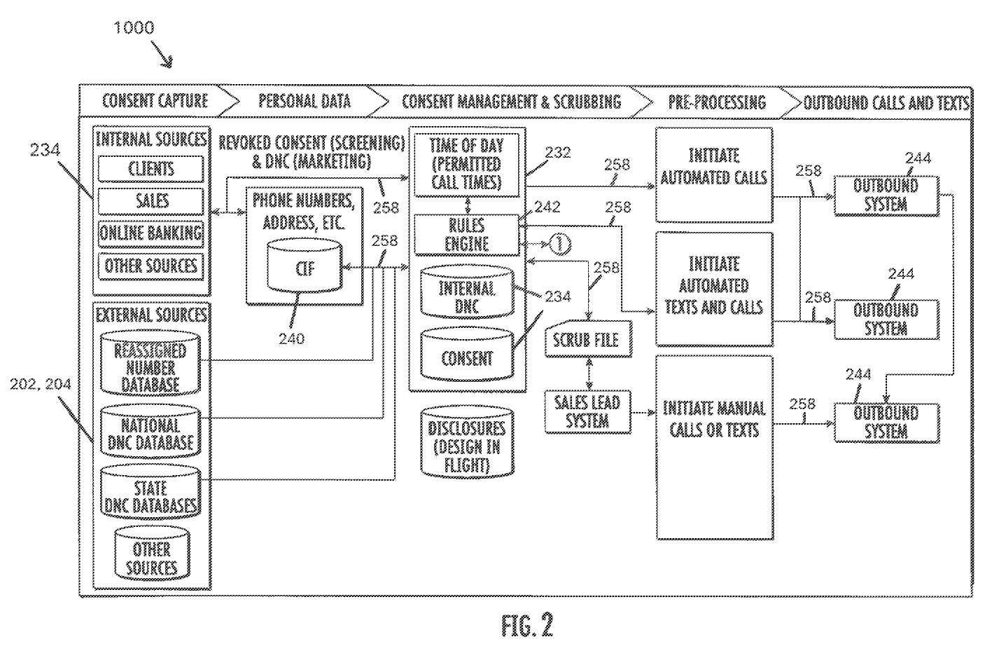

As discussed hereinabove, one of the programs 230 of the enterprise system 200 may be the data privacy application 232, an architecture 1000 of which is shown in FIG. 2. A framework illustrated in FIG. 2 shows a relationship of internal and external data sources, consent management, and consumer communication with capabilities of the enterprise system 200. The data privacy application 232 may be used by the enterprise system 200 to improve process consistency and network traffic flow, while maintaining law and regulatory compliance.

In an embodiment, the enterprise system 200 is caused to allow defining a plurality of preferences corresponding to plurality of fields of the data privacy application 232, where the plurality of fields may include sensitive data associated with a user profile. The sensitive data may include personally identifiable information (PII) data and domain specific data. Herein, the PII data may refer to the data that may be utilized for determining identity of the user. Examples of fields including the PII data may include permanent account numbers, date of birth, e-mail address, residential address, and telephone numbers, for example. The domain specific data includes the data that can pose a risk or affect the user 110 financially or otherwise, if disclosed in public. In an embodiment, the domain specific data may include domain specific fields, and can be generated by the enterprise system 200. Examples of said domain specific data for a financial institution such as a bank may include financial information such as debit and/or credit card numbers, CVV number, account balance, card expiry date, and other such fields, for example.

Features of the data privacy application 232 include, but are not limited to ingest and store existing and unique user identifiers, (e.g. user ID, postal address, phone numbers, email address), global opt-outs for marketing communications (e.g. email, phone call, text, direct mail), Telephone Consumer Protection Act (TCPA) regulations, and/or California Privacy Rights Act (CPRA) opt-outs (e.g. third party sharing/selling, affiliate sharing/selling, limited use of sensitive personal data, automated decision making) via batch and real-time application program interfaces (APIs); establish a single view of user consent and preferences, which are aligned to unique user identifiers (e.g. user ID, postal address, phone number, email address); enable front-end user interfaces and other programs/applications of the enterprise system 200 to read and write to a consent master via API or batch. Outputs via batch may include a consent master extract; define and manage technical rules based on approved requirements of the enterprise for global marketing opt-outs, TCPA and/or CPRA opt-outs, to enable processing and suppression of data based on user 110 provided consent and preferences; apply decision and, as required, either flag or suppress, scrub, and/or filter records based on user consent and preferences and the applicable rules; enable a manual search by a unique ID to return a user’s consent and preference data; and enable an upload of marketing lists (e.g. email address, phone numbers, and/or postal addresses), manually and/or automatically, to determine permissibility for marketing communications based on user provided consent and preferences.

The data privacy application 232 allows the users 110 to view existing preferences and/or input preferences via the user device, referring to either or both of the computing device 104 and the mobile device 106. User preferences may include limitations to how the personal information of the users 110 may be used by the enterprise and/or the enterprise system 200. A notification may be transmitted to the user device, referring to either or both of the computing device 104 and the mobile device 106, notifying the users 110 that a change to their preferences has occurred. In certain embodiments, the user preferences may be used in the enterprise system 200 as a filter, suppression rules, and/or criteria in other programs and applications of the enterprise system 200 such as marketing systems and applications, for example. In an example embodiment, the data privacy application 232 may be accessed via a computing device, for example, by the agent device 212 of the agent 210 of FIG. 1.

Operations of the method, and combinations of operation in the method, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of a system and executed by at least one processor in the system. Any such computer program instructions may be loaded onto a computer or other programmable system (for example, hardware) to produce a machine, such that the resulting computer or other programmable system embody means for implementing the operations specified in the method.

As depicted in FIG. 2, the data privacy application 232 may utilize and/or be in communication via the network 258 with a customer information file (CIF) 240, the one or more external systems 202, 204 to access the external databases (e.g., the reassigned number database (RND), the national do-not-call (DNC) database, the state do-not-call (DNC) databases, the public safety telephone number database, the wireless block and VOIP ID database, the professional litigator database, and the like); the one or more internal databases 234 of the computing system 206 (e.g., the internal enterprise do-not-call (DNC) database, the revoked consent database); at least one of the applications 230 upstream and/or downstream relative to data flow of the data privacy application 232; a data filter; and/or a marketing module. It should be appreciated that the data privacy application 232 may utilize more or less of the applications 230 and/or the systems 202, 204, 206 of the enterprise system 200.

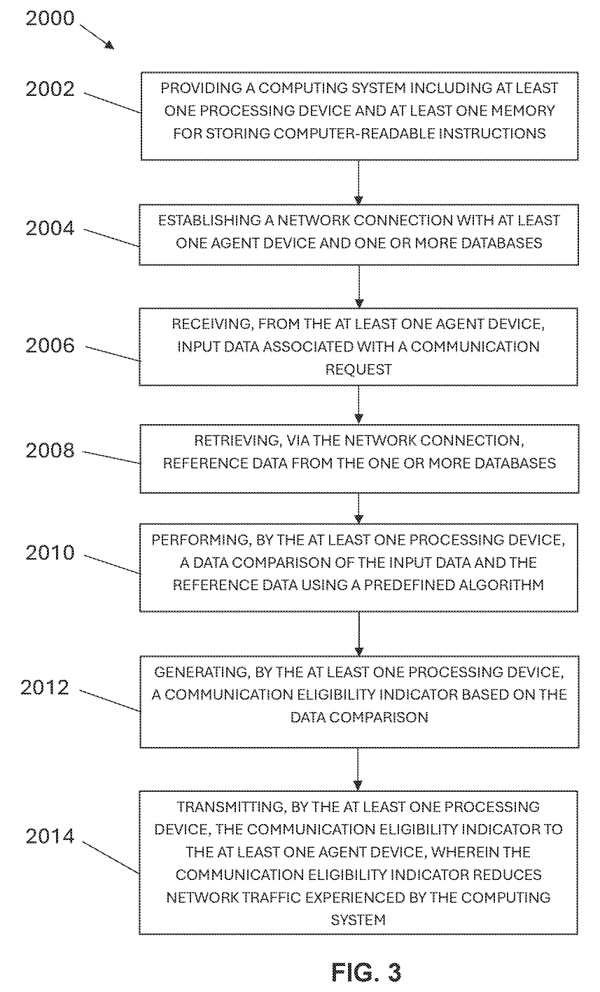

FIG. 3 illustrates an exemplary method 2000 of improving network traffic flow according to an embodiment of the present disclosure. At step 2002, the agent 210 executes the data privacy application 232 using the agent device 212 in communication with the computing system 206 including the processing device 220 and the memory device 222. Upon execution of the data privacy application 232, the computing system 206 is configured to establish a network connection with the agent device 212 and/or one or more of the external databases of the external systems 202, 204 and/or one or more of the internal databases 234, at step 2004. At step 2006, the computing system 206 is configured to receive, from the agent device 212, input data associated with a communication request of an agent 210. In some embodiments, the input data includes at least one telephone number of one or more of a specific user 110 and/or a potential client. In other embodiments, the input data is a batch of telephone numbers from various users 110 and/or potential clients. The computing system 206 is further configured to retrieve, via the network 258, reference data from the one or more of the external databases of the external systems 202, 204 and/or one or more of the internal databases 234 at step 2008. As described herein, the external databases of the external systems 202, 204 and/or the internal databases 234 of the computing system 206, may include but not limited to the RND database, the external DNC databases, the internal DNC databases, as well as the public safety telephone number database, the wireless block and VOIP ID database, the professional litigator database, and/or the revoked consent database. The processing device 220 of the computing system 206, at step 2010, is configured to perform a data comparison of the input data and the reference data using a predefined algorithm, for example, table lookup, binary search, linear search, fuzzy matching, and the like. It should be appreciated that various other algorithms may be utilized if desired. Based on the data comparison, the computing system 206, particularly the processing device 220, is configured to generate a communication eligibility indicator associated with the communication request, at step 2012. The communication eligibility indicator is then transmitted, at step 2014, by the processing device 220 to the agent device 212 for use by the agent 210 to determine whether a communication may be transmitted to the specific user 110 and/or the potential client.

In a non-limiting example, when the input data associated with the communication request matches the reference data from the external databases of the external systems 202, 204 and/or the internal databases 234 of the computing system 206, the data privacy application 232, via the processing device 220, is configured to generate a communication eligibility indicator representative of “NO” or denied. Accordingly, the agent device 212, and thereby the agent 210, is prevented from transmitting communications to at least one device of the specific user 110 (e.g. the user device referring to either or both of the computing device 104 and the mobile device 106) and/or the potential client. In certain embodiments, the data privacy application 232, using the processing device 220, is configured to further generate and transmit to the agent device 212 an electronic communication containing a specific basis for the communication eligibility indicator representative of “NO” or denied for use by the agent 210. For example, the specific basis may identify one or more of the external databases of the external systems 202, 204 and/or the internal databases 234 of the computing system 206 that contain the reference data matching the input data.

When the input data associated with the communication request does not match the reference data (i.e., a non-match) from the external databases of the external systems 202, 204 and/or the internal databases 234 of the computing system 206, the data privacy application 232, via the processing device 220, is configured to generate a communication eligibility indicator representative of “YES” or permitted. Accordingly, the agent device 212, and thereby the agent 210, is permitted to transmit at least one communication to the at least one device of the specific user 110 (e.g. the user device referring to either or both of the computing device 104 and the mobile device 106) and/or the potential client. As a non-limiting example, the at least one communication may be a text message and/or a telephone call. In certain instances, the computing system 206 may transmit such communication manually and/or automatically and/or using one or more outbound systems 244. In certain embodiments, however, the data privacy application 232 may be further configured to apply one or more filters, guidelines, and/or rules (e.g., rules engine 242) to the input data and/or associated communication requests – either before or after generating the communication eligibility indicator - to ensure compliance with user-specific and/or potential client-specific data privacy and marketing preferences. For instance, the data privacy application 232 may be configured to determine permissible communication times and methods (e.g., daytime, weekdays, telephone, text, etc.) for transmitting the communications to the at least one device of the specific user 110 (e.g. the user device referring to either or both of the computing device 104 and the mobile device 106) and/or the potential client based on the data privacy and marketing preferences. The filtered input data and/or associated communication request is then transmitted to the agent device 212 for use by the agent 210.

It should be appreciated that the data privacy application 232, using the processing device 220, may process the input data associated with the communication request separately and/or using a batch processing method.

The data privacy application 232 may be a mechanism to control and manage use of the personal information of the user 110 by the enterprise system 200. The data privacy application 232 enables compliance with legal and regulatory requirements as well as a broader, more dynamic use of data. Features of the data privacy application 232 are expandable as user expectations and privacy regulations evolve over time.

It is understood that the above-defined databases and/or preferences are mentioned for example purposes and should not be considered as limiting to various embodiments of the disclosure.

Since the enterprise system 200 is extensible and flexible, the databases and/or preferences defined herein are not static and can be updated by adding new and/or deleting the existing databases and/or preferences or replacing the existing databases and/or preferences with the new databases and/or preferences.

Among other benefits, the data privacy application 232 significantly enhances the operational efficiency and architectural robustness of the enterprise system 200. First, it optimizes network utilization by intelligently suppressing redundant or non-compliant communications from the agent device 212. These communications, often triggered by tasks executed by human agents 210 or the computing system 206, may otherwise risk breaching regulatory or legal boundaries. By preemptively filtering such interactions, the enterprise system 200 ensures compliance while reducing bandwidth consumption and network traffic experienced by the computing system 206. This enables the enterprise system 200 to enforce data minimization principles and streamline processing workflows by eliminating unnecessary or legally non-compliant data interactions. As a result, the computing system 206 benefits from a simplified logic path and reduced computational overhead. Second, the data privacy application 232 further reduces network load and processing latency by consolidating data comparison operations. Instead of performing multiple sequential comparisons of input data associated with communication requests across different time instances, the computing system 206 may execute a single, parallelized comparison against multiple external and internal databases of the enterprise system 200. This not only accelerates data validation processes but also enhances data integrity and consistency across the enterprise system 200.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A system that improves network traffic flow, comprising:
a computing system including at least one processing device and at least one memory for storing computer-readable instructions, wherein, upon execution of the computer-readable instructions, the computing system is configured to:
establish a network connection with at least one agent device and one or more databases;
receive, from the at least one agent device, input data associated with a communication request;
retrieve, via the network connection, reference data from the one or more databases;
perform, by the at least one processing device, a data comparison of the input data and the reference data using a predefined algorithm;
generate, by the at least one processing device, a communication eligibility indicator based on the data comparison; and
transmit, by the at least one processing device, the communication eligibility indicator to the at least one agent device, wherein the communication eligibility indicator reduces network traffic experienced by the computing system.

2. The system of claim 1, wherein the input data is a telephone number of a specific user and/or a potential client.

3. The system of claim 1, wherein the one or more databases includes a reassigned number database.

4. The system of claim 1, wherein the one or more databases includes a national do-not-call database.

5. The system of claim 1, wherein the one or more databases includes at least one state do-not-call database.

6. The system of claim 1, wherein the one or more databases includes a public safety telephone number database.

7. The system of claim 1, wherein the one or more databases includes a wireless block and VOIP ID database.

8. The system of claim 1, wherein the one or more databases includes a litigator database.

9. The system of claim 1, wherein the one or more databases includes an internal do-not-call database.

10. The system of claim 1, wherein the one or more databases includes a revoked consent database.

11. The system of claim 1, wherein the data comparison of the input data and the reference data is performed using a batch process.

12. The system of claim 1, wherein the communication eligibility indicator is representative of “NO” or denied communication from the at least one agent device.

13. The system of claim 1, wherein the communication eligibility indicator is representative of “YES” or permitted communication from the at least one agent device.

14. The system of claim 13, wherein, upon execution of the computer-readable instructions, the computing system is further configured to transmit a permitted communication from the at least one agent device manually and/or automatically using one or more outbound systems.

15. The system of claim 1, wherein, upon execution of the computer-readable instructions, the computing system is further configured to generate, by the at least one processing device, an electronic communication containing a specific basis for the communication eligibility indicator.

16. The system of claim 15, wherein, upon execution of the computer-readable instructions, the computing system is further configured to transmit, by the at least one processing device, the electronic communication containing the specific basis for the communication eligibility indicator.

17. The system of claim 15, wherein the specific basis identifies at least one of the one or more databases that contain the reference data matching the input data.

18. The system of claim 1, wherein, upon execution of the computer-readable instructions, the computing system is further configured to filter the input data and/or the associated communication request using user-specific and/or potential client-specific data privacy preferences and/or marketing preferences.

19. The system of claim 18, wherein, upon execution of the computer-readable instructions, the computing system is further configured to determine permissible communication times and/or methods based on the filtered input data and/or the associated communication request.

20. A method that improves network traffic flow, comprising:
providing a computing system including at least one processing device and at least one memory for storing computer-readable instructions;
establishing a network connection with at least one agent device and one or more databases;
receiving, from the at least one agent device, input data associated with a communication request;
retrieving, via the network connection, reference data from the one or more databases;
performing, by the at least one processing device, a data comparison of the input data and the reference data using a predefined algorithm;
generating, by the at least one processing device, a communication eligibility indicator based on the data comparison; and
transmitting, by the at least one processing device, the communication eligibility indicator to the at least one agent device, wherein the communication eligibility indicator reduces network traffic experienced by the computing system.
